(19) United States
(12) Patent Application Publication
(10) Pub. No.: US 2025/0265599 A1
(43) Pub. Date: Aug. 21, 2025

(54) ARTIFICIAL INTELLIGENCE BASED CUSTOMER DUE DILIGENCE ERROR PROPENSITY PREDICTION MODELS

(71) Applicant: NTT DATA Services, LLC, Plano, TX (US)

(72) Inventors: Ramprassath T C, Chennai (IN); Raghava Kothapalli, Bangalore (IN); Magesh T, Karumbur (IN); Mohan Kumar Icourt Durai, Chennai (IN); Sivakumar Rajendran, Nammakkal (IN); Venkatasubramaniam R, Chennai (IN); Gopinath Narayanswani Dharmarajan, Chennai (IN); Gopa Kumar S R, Chennai (IN); Shabi Christopher, Peterborough (GB); Rohit Puri, Plano, TX (US)

(21) Appl. No.: 18/583,352

(22) Filed: Feb. 21, 2024

(51) Int. Cl. G06Q 30/018

(52) U.S. Cl. CPC G06Q 30/018

(57) ABSTRACT

Methods, systems, and computer-program products for creating a model for predicting error propensity are disclosed. The method includes receiving input data including historical know your client (KYC) audit cases and associated error data, extracting KYC audit attributes from the historical KYC audit cases and associated error data, receiving analyst attributes, constructing a dataset from input variables including at least one of the KYC audit attributes or the analyst attributes, creating at least one artificial intelligence (AI) model based, at least in part, on the dataset, and selecting one of the at least one AI model for predicting error propensity for a customer due diligence process.

### TECHNICAL FIELD

The present disclosure relates generally to error propensity prediction models and more particularly, but not by way of limitation, to artificial intelligence based customer due diligence error propensity prediction models.

### BACKGROUND

This section provides background information to facilitate a better understanding of the various aspects of the disclosure. It should be understood that the statements in this section of this document are to be read in this light, and not as admissions of prior art.

Know your customer (KYC) review checks are legal and regulatory requirements which have been introduced globally and are now standard practices being followed by financial institutions. KYC reviews are generally mandatory processes for financial institutions which establish customer identity, identifies financial fraud, identifies funding for illegal activities (e.g., terrorism), and assesses money laundering risks associated with customers. KYC reviews provide protection from fraud and losses due to illegal funds and/or transactions. Failure to perform KYC audits may lead to severe penalties and/or cancellation of licenses of the financial institutions.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In one or more embodiments, the present disclosure relates to a method for creating a model for predicting error propensity. The method includes receiving input data including historical know your client (KYC) audit cases and associated error data, extracting KYC audit attributes from the historical KYC audit cases and associated error data, receiving analyst attributes, constructing a dataset from input variables including at least one of the KYC audit attributes or the analyst attributes, creating at least one artificial intelligence (AI) model based, at least in part, on the dataset, and selecting one of the at least one AI model for predicting error propensity for a customer due diligence process.

In one or more embodiments, the present disclosure relates to a system for creating a model for predicting error propensity. The system includes memory and at least one processor coupled to the memory and configured to implement a method. The method includes receiving input data including historical KYC audit cases and associated error data, extracting KYC audit attributes from the historical KYC audit cases and associated error data, receiving analyst attributes, constructing a dataset from input variables including at least one of the KYC audit attributes or the analyst attributes, creating at least one AI model based, at least in part, on the dataset, and selecting one of the at least one AI model for predicting error propensity for a customer due diligence process.

In one or more embodiments, the present disclosure relates to a computer-program product having a non-transitory computer-usable medium with computer-readable program code embodied therein. The computer-readable program code is adapted to be executed to implement a method. The method includes receiving input data including historical KYC audit cases and associated error data, extracting KYC audit attributes from the historical KYC audit cases and associated error data, receiving analyst attributes, constructing a dataset from input variables including at least one of the KYC audit attributes or the analyst attributes, creating at least one AI model based, at least in part, on the dataset, and selecting one of the at least one AI model for predicting error propensity for a customer due diligence process.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates an example system utilizing artificial intelligence (AI) based customer due diligence (CDD) error propensity prediction models according to certain embodiments of the disclosure.

FIG. 2 illustrates an example computer system according to certain embodiments of the disclosure.

FIG. 3 illustrates an example method for creating and selecting AI based CDD error propensity prediction models according to certain aspects of the disclosure.

FIG. 4 illustrates an example method for processing a request relating to know your customer (KYC) data according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Customer due diligence (CDD) and/or KYC are activities that financial institutions perform to identify any risks that the customer poses to a financial institution. Customers may undergo major changes over time, from adopting new transaction channels to signing up for new products and services, as well as altering income levels, organizational structures, transaction patterns, nations of operation, and the like. Financial institutions that have not updated customer information in their records may be exposed to the danger of obsolete information, incorrect customer information, business case errors and risk profiles, erroneous expected behavior profiles, and undiscovered networks and linkages. As a result, financial institutions may use inaccurate customer segmentation and scenarios for transaction monitoring and detecting anomalous consumer behavior.

Furthermore, KYC standards are viewed as a one-time goal to achieve and/or a deadline to accomplish. KYC is all about getting to know the customer and making sure the customer actions match what they stated and agreed to as part of a customer relationship agreement with the financial institution. Customers are generally obligated to report to the financial institution about any changes; this however, does not always occur effortlessly.

For financial institutions, the scale of periodic client and counterparty reviews may be daunting because such reviews may include thousands of clients and thousands upon thousands of pages of data and documents that must be examined. With clients classified according to the level of risk they pose to the financial institution (e.g., high, medium, or low risk), the goal is to ensure that adequate resources are allocated to higher risk clients, who require more frequent reviews and involve more complexity than their lower risk counterparts. The time and resources necessary to perform a periodic review may be substantial, depending on the size of the organization, the number of clients, and associated risk categories.

Similarly, traditional responses to customer reviews have primarily included using brute force solutions to the problem, that is, utilizing as many people and as much money as possible to address customer reviews and/or problems. Since KYC reviews are being performed manually, possibility of human error in such processes can be high, leaving the business susceptible to fraud. In addition, manual methods require hours of labor, and a customer may be off-boarded at any point for a variety of risks and/or compliance reasons.

In an effort to save time and money and to deploy skilled people elsewhere within the business, financial institutions turn to intelligent process automation (IPA) to do the manual work that involves performing comprehensive and thorough audits. IPA reduces the time, cost, and risk involved in these activities, which enables organization to provide a better customer experience and engages in demonstrating compliance with regulators.

Financial institutions use multi-layered audit structures for auditing KYC review operations. These multi-layered audit structures contribute to achieving the highest operational accuracy but, on the other hand, results in higher auditing costs. Therefore, artificial intelligent (AI) based error prediction model which identifies KYC audit cases, based on business attributes, and with high propensity for error are needed. The models also need to discover trends and patterns across different review scenarios and provide probability scores based on attributes identified.

As such, the disclosure describes implementations using machine learning models that can audit KYC review operations efficiently and with high operational accuracy, which can reduce audit costs by about 30%. The machine learning approaches disclosed herein reduce the KYC review audit costs by identifying cases with high propensity for error, thus improving the efficiency of the auditing process. Attributes contributing to the models disclosed herein include, without limitation, number of associates performing screening, review type, such as, for example, business units or sub-business units, peer reviewer location, peer reviewer primary processes, number of individuals screened, risk assessments rejected, risk levels, analyst tenure, number of documents purchased, and combinations of the same and like.

Disclosed herein are AI based CDD error propensity prediction models that process various types of KYC reviews for different business channels. For example, using models generated as disclosed herein, the error rate of the KYC review can be reduced at about 0.3% per 50,000 cases. Thus, with the automated KYC review process, the cost of quality assurance can be reduced by 30% without any significant change in accuracy. In various embodiments, the models use historical data and machine learning algorithms for discovering trends and patterns across different review scenarios in order to predict the KYC reviews with zero propensity for error.

In some embodiments, the machine learning model is created based on business attributes which impact accuracy. The attributes in the machine learning model include, for example, review types, analyst attributes including, but not limited to, education, overall experience, body of individuals (BOI) tenure and shift timings in order to perform the error propensity prediction, average handling time at different stages of the review by different roles, number of times the case has been referred to money laundering reporting officers, and number of documents required to process the case completely. Based on these attributes the models may predict KYC cases with higher propensity of errors. When the machine learning model identifies KYC cases with higher error propensity, the need to audit larger number of KYC cases can be avoided, thus the audit time and costs can be reduced by focusing only those cases with a high propensity for error which in turn achieves quality standards.

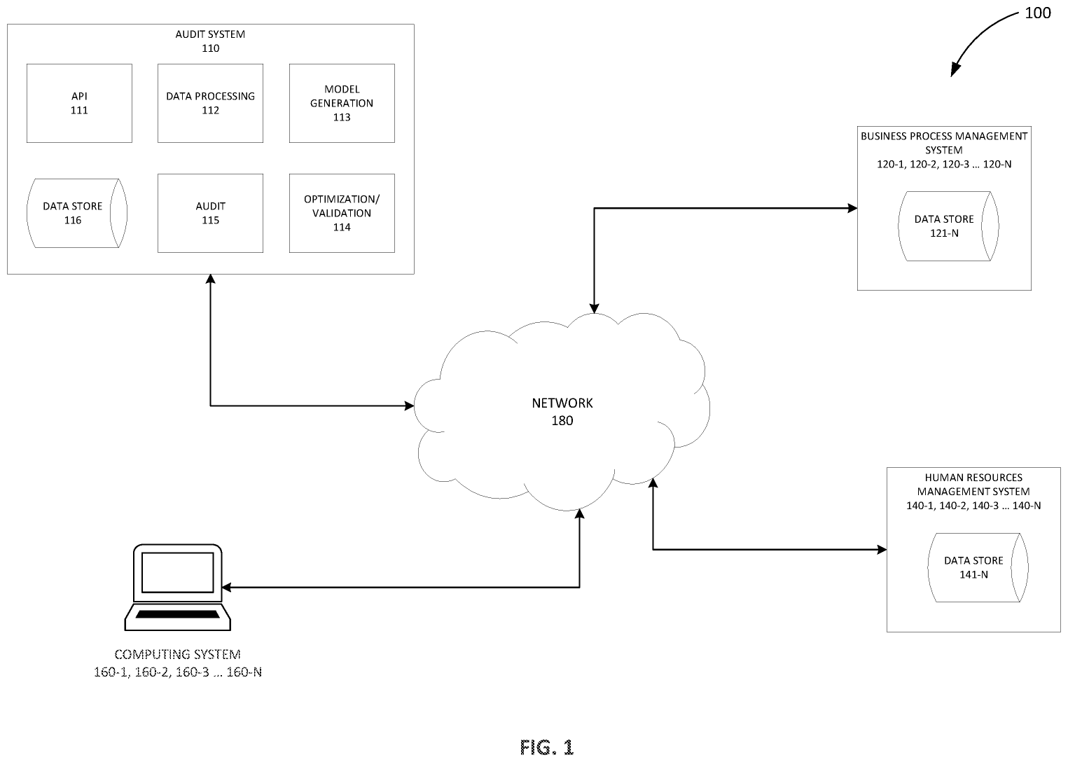

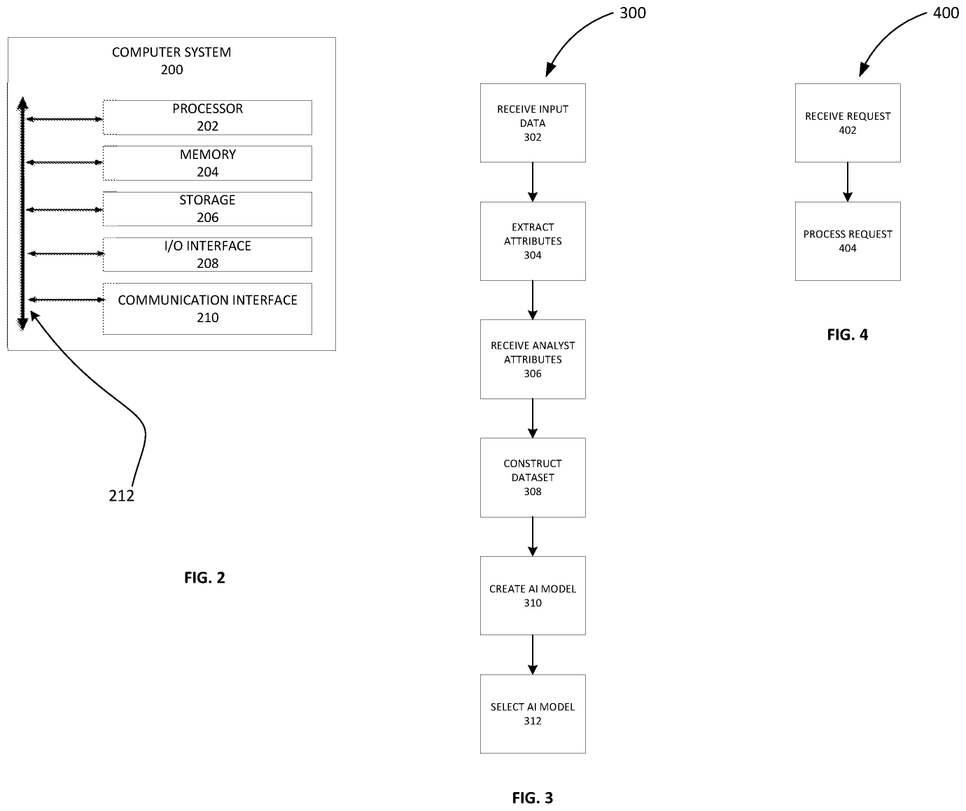

FIG. 1 illustrates an example system 100 utilizing AI based CDD error propensity prediction models according to certain embodiments of the disclosure. In general, system 100 may include, for example, an audit system 110, business process management system 120-1, 120-2, 120-3 . . . 120-N (collectively referred to as “business process management system 120”) each having a data store 121-N(collectively referred to as data store 121), human resources management system 140-1, 140-2, 140-3 . . . 140-N (collectively referred to as human resources management system 140) each having a data store 141-N (collectively referred to as data store 141), and computing system 160-1, 160-2, 160-3 . . . 160-N (collectively referred to as computing system 160) each communicatively coupled via a network 180 (e.g., the Internet, a public cloud system, a private cloud system, and the like). In certain embodiments, each of the audit system 110, business process management system 120, and/or human resource management system 140 may include a computer system 200 as described further in FIG. 2. Furthermore, in certain embodiments, computing system 160 may be representative of computer system 200 as described in further detain in FIG. 2.

As shown in FIG. 1, the audit system 110 may include an application programming interface (API) 111, a data processing module 112, a model generation module 113, an optimization/validation module 114, an audit module 115, and data store 116. In certain embodiments, the data store 116 may be representative of storage 206 as described in FIG. 2. While the audit system 110 is described as a single audit system 110, in various embodiments, the audit system 110 may include a plurality of audit systems 110. For example, the system 100 may include an audit system 110 for each tenant (e.g., financial institutions, audit firms, and the like) on the network 180 (e.g., a private and/or public cloud system) or within an organization operating on the network 180. In such embodiments, each audit system 110 can interact with corresponding business process management systems 120, human resource management systems 140, and computing systems 160 over the network 180. In various embodiments, when system 100 includes a plurality of audit systems 110, the network 180 may be a plurality of private and/or public cloud systems for each tenant.

In various embodiments, the audit system 110 (e.g., the data processing module 112) may access input data from the business process management system 120 from data store 121 of, for example, an organization, via the API 111. In some embodiments, the data processing module 112 retrieves the input data from the business processing management system 120 responsive to a user request initiated from, for example, the computing system 160. In some embodiments, the business process management system 120 periodically sends the input data to the audit system 110.

In some embodiments, the input data is stored in data store 116 after the input data is accessed. In certain embodiments, the input data may include historical KYC audit cases and associated error data. In certain embodiments, the historical KYC audit cases include cases for which an audit has already been performed. In certain embodiments, after the input data is stored in data store 121, the data processing module 112 can extract KYC audit attributes from the historical KYC audit cases and associated error data. Table 1, shown below, illustrates various audit attributes according to aspects of the disclosure.

TABLE 1

| Category | Attribute Name | Category | Attribute Name |
|---|---|---|---|
| KYC Review | Review Type | KYC Review | Review Identification |
| Attributes | Code | Steps | Code |
| Source: | Business Channel | Source: | Associate Name |
| Business | Code | Business | Code |
| Process | Risk Level | Process | Reviewed On |
| Management | Review Identification | Management | Start Time |
| System | Code | System | |
| | Jurisdiction | | End Time |
| | Trading Information | | Process Time |
| | Non-Disclosure | | |
| | Vessel Involvement | | Status |
| | Vessel Name Screening | | Reviewer Type |
| | Vessel International | Category | Attribute Name |
| | Maritime Organization | | |
| | Number Screening | | |
| | Shipment Date | Analyst | Associate |
| | | Profile | Name Code |
| | Portal Date | Source: | Primary Process |
| | Number of Individuals | Human | Location |
| | Number of Entities | Resources | Highest Qualification |
| | Number of Matches | Management | Total Experience |
| | | System | (Years) |
| | Decision | | BOI Experience |
| | | | (Years) |
| | Number of Global | | BOI Date of Joining |
| | Business Registry | | (DOJ) |
| | Documents Purchased | | |

In certain embodiments, the data processing module 112 may access analyst attributes (shown above in Table 1) from the human resources management system 140 from data store 141 of, for example, an organization, via the API 111. In some embodiments, the data processing module 112 retrieves the analyst attributes from the human resources management system 140 responsive to a user request initiated from, for example, the computing system 160. In some embodiments, the human resources management system 140 periodically sends the input data to the audit system 110.

In some embodiments, the analyst attributes are stored in data store 116 after the analyst attributes are accessed. In certain embodiments, analyst attributes may be associated with analysts that perform KYC audit processes. In certain embodiments, the analyst attributes may additionally include, for example, education, overall experience, BOI tenure, shift timings, and combinations of the same and like. In certain embodiments, the data processing module 112 can extract specific attributes, as needed, from the analyst attributes. For example, the data processing module 112 can extract analyst attributes associated with a specific analyst.

In certain embodiments, the data processing module 112 may construct a dataset from input variables. In some embodiments, the input variables may include, without limitation, the KYC audit attributes, the analyst attributes, and combinations thereof. Additionally, in further embodiments, the data processing module 112 may perform various data preparation processes on the dataset. For example, in certain embodiments, the data processing module 112 can perform cleansing processes on the dataset. In certain embodiments, the cleansing may include, without limitation, inputting missing values to respective columns in the data set, encoding categorical variables of the dataset, scaling the dataset, and combinations of the same and like. In some embodiments, inputting missing values to respective columns in the dataset may be performed using K-nearest neighbor (KNN) algorithms and the like. In various embodiments, if missing values are identified, the audit system 110 can alert a user (e.g., a user of computing system 160) that data is missing. In such embodiments, information can be stored in, for example, data store 116 relating to the amount of missing data, and may also be associated with the analyst involved in the KYC audit that has missing data. In this manner, proficiency and accuracy for each auditor may be maintained based on missing data.

In various embodiments, the encoding categorical variables of the dataset may include, without limitation, label encoder methods, frequency encoder methods, one-hot encoder methods, and combinations of the same and like. In some embodiments, scaling the dataset can be accomplished via, for example, using standard scalar techniques. In certain embodiments, the dataset may be stored in data store 116.

In certain embodiments, the audit system 110 (e.g., the model generation module 113) may implement feature engineering on the dataset. In certain embodiments, the model generation module 113 may implement feature engineering for categorical variables of the dataset. In some embodiments, the feature engineering process involves creating group-by features using categorical variables based, at least in part, on exploratory data analysis (EDA). In some embodiments, the group-by feature is created by finding an association between two or more categorical variables. In certain embodiments, the feature engineering process includes creating statistical columns to improve the AI model functionality.

Additionally, in some embodiments, the model generation module 113 may create AI models based, at least in part, on the dataset. In some embodiments, creating AI models may be accomplished by using features (e.g., from the feature engineering), by means gradient boosting methods, by positive and un-sampled machine learning, by deep learning based on, for example, long short-term memory (LSTM) and support vector machine (SVM) methods, by under sampling methods, and combinations of the same and like. In certain embodiments, the AI models are created based, at least in part, on features associated with the feature engineering. In some embodiments, the AI models are stored within data store 116.

In certain embodiments, the audit system 110. (e.g., the optimization/validation module 114) can perform optimizing and/or validating methods on the AI models. In some embodiments, the optimization/validation module 114 may optimize and/or validate the AI models using hyper parameter optimization methods, grid search and Bayesian optimization methods, voting and stacking methods, and combinations of the same and like.

In various embodiments, the audit system 110 (e.g., the audit module 115) may select one of the AI models (e.g., from data store 116) for predicting error propensity for a customer due diligence process. In some embodiments, the customer due diligence is a KYC process. In certain embodiments, the AI model selected may be selected based on various criteria. For example, the AI model may be selected based on attributes contributing to the AI model such as, for example, number of associates performing screening, review type, such as, for example, business units or sub-business units, peer reviewer location, peer reviewer primary processes, number of individuals screened, risk assessments rejected, risk levels, analyst tenure, number of documents purchased, and combinations of the same and like. In some embodiments, the selected AI model may be selected for predicting error propensity for a customer due diligence process.

Additionally, the AI model can be selected based on analyst attributes that may include, for example, review types, analyst attributes including, but not limited to, education, overall experience, BOI tenure and shift timings in order to perform the error propensity prediction, average handling time at different stages of the review by different roles, number of times the case has been referred to money laundering reporting officers, and number of documents required to process the case completely. In some embodiments, the AI model is selected based on, for example, discovery of trends and patterns across different review scenarios that facilitate in the prediction of KYC reviews with low to zero propensity for error.

In certain embodiments, the audit module 115 may receive a KYC request and process the KYC request with the selected AI model. In some embodiments, the KYC request may include, without limitation, KYC requests processed by a specific analyst in order to identify analyst performance, a KYC request for a business engaging in financial activity with a financial institution, a series of KYC requests for a specific business in order to audit KYC activity for the specific business, and combinations of the same and like. In some embodiments, the audit module 115 may receive the KYC request via a user of the computing system 160.

In certain embodiments, processing the KYC request may include, without limitation, identifying and verifying the identity of a client when opening an account, periodically identifying and verifying the identity of a client of an open account, periodically identifying and verifying transactions (e.g., financial transactions) made by a client, and combinations of the same and like. In some embodiments, processing the KYC request may include, for example, identifying individuals suspected of criminal activity, reviewing data associated with jurisdictional sanctions related to a company and/or individual, provide intelligence on companies and/or individuals suspected of taking part in bribery and/or money laundering, identifying politically exposed persons, and combinations of the same and like.

In various embodiments, the processing the KYC request includes identifying cases with high propensity for error while improving process efficiency, predicting reviews with low to zero propensity for error, identifying and/or discovering trends and/or patterns across different KYC review scenarios using historical data and machine learning algorithms, and combinations of the same and like. In some embodiments, processing the KYC request may include classifying a client associated with the KYC request as high, medium, or low risk. In some embodiments, the processing the KYC request provides probability scores based on attributes related to a client associated with the KYC request. In some embodiments, the probability scores are base, at least in part, on risk associated with the customer. In various embodiments, the processing the KYC request includes identifying cases with high propensity for error.

As shown in FIG. 1, the system 100 may include one or more business process management systems 120. In certain embodiments, the business process management system 120 may include a computer system 200 as described further in FIG. 2. In certain embodiments, the business process management system 120 can be a distributed business process management system 120. In certain embodiments, each business process management system 120 may include a data store 121, such as storage 206 as described further in FIG. 2. In various embodiments, the business process management system 120 may include KYC audit data within data store 121. In some embodiments, the KYC audit data may include, without limitation, historical KYC audit cases and associated error data. In certain embodiments, the historical KYC audit cases include cases for which an audit has already been performed.

As shown in FIG. 1, the system 100 may include one or more human resources management systems 140. In certain embodiments, the human resources management system 140 may include a computer system 200 as described further in FIG. 2. In certain embodiments, the human resources management system 140 can be a distributed human resources management system 140. In certain embodiments, each human resources management system 140 may include a data store 141, such as storage 206 as described further in FIG. 2. In various embodiments, the human resources management system 140 may include analyst attributes as shown above in Table 1. In certain embodiments, analyst attributes may be associated with analysts that perform KYC audit processes. In certain embodiments, the analyst attributes may additionally include, for example, education, overall experience, BOI tenure, shift timings, and combinations of the same and like.

As shown in FIG. 1, the system 100 may include one or more computing systems 160. In certain embodiments, computing system 160 may be representative of computer system 200 as described in further detain in FIG. 2. In various embodiments, the computer system 160 may communicate with one or more of the audit system 110, the business process management system 120, and/or the human resource management system 140. The computing system 160, in certain embodiments, may be used to initiate procedures, such as those discussed below relative to FIGS. 3 and 4, by accessing an interface of the audit system 110. In some embodiments, the interface of the audit system 110 may include, without limitation, a graphical user interface (GUI) operable to access the audit system 110, a front end for the audit system 110 (e.g., a website frontend), a computer program operable to interact with the audit system 110, and combinations of the same and like.

It should be noted that while each module of the audit system 110 may be operated independently, each module within the audit system 110 may work in parallel or in tandem with other modules within the audit system 110. As such, each module within the audit system 110 can independently, or in combination, perform similar and/or related tasks, and are described as separate modules for illustrative purposes only. Additionally, while the audit system 110 is described relative to FIG. 1 as including the API 111, the data processing module 112, the model generation module 113, the optimization/validation module 114, and the audit module 115, in certain embodiments, the abovedescribed modules may be expanded into more modules, or reduced into fewer modules. In such embodiments, each module of the audit system 110 may be expanded into multiple modules or confined to fewer modules without deviating from the scope of the disclosure. Additionally, while FIG. 1 is described relative to a single audit system 110, the audit system 110 may be expanded into multiple audit systems 110 and/or a plurality of audit systems 110 without deviating from the scope of the disclosure.

FIG. 2 illustrates an example computer system 200. Computer system 200 may include a processor 202, memory 204, storage 206, an input/output (I/O) interface 208, a communication interface 210, and a bus 212. Although this disclosure describes one example computer system including specified components in a particular arrangement, this disclosure contemplates any suitable computer system with any suitable number of any suitable components in any suitable arrangement. As an example and not by way of limitation, computer system 200 may be an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 200 may include one or more computer systems 200; be unitary or distributed, span multiple locations, machines, or data centers; or reside in a cloud, which may include one or more cloud components in one or more networks. Where appropriate, computer system 200 may perform, at different times or at different locations, in real time or in batch mode, one or more steps of one or more methods described or illustrated herein.

Processor 202 may include hardware for executing instructions, such as instructions in or comprising a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. Processor 202 may include one or more internal caches for data, instructions, or addresses.

In particular embodiments, memory 204 includes main memory for storing instructions for processor 202 to execute or data for processor 202 to operate on. In particular embodiments, one or more memory management units (MMUs) reside between processor 202 and memory 204 and facilitate accesses to memory 204 requested by processor 202. In particular embodiments, memory 204 includes random access memory (RAM). This disclosure contemplates any suitable RAM.

In particular embodiments, storage 206 includes mass storage for data or instructions. As an example and not by way of limitation, storage 206 may include a removable disk drive, flash memory, an optical disc, a magneto-optical disc, magnetic tape, or a Universal Serial Bus (USB) drive or two or more of these. Storage 206 may include removable or fixed media and may be internal or external to computer system 200. Storage 206 may include any suitable form of non-volatile, solid-state memory or read-only memory (ROM).

In particular embodiments, I/O interface 208 includes hardware, software, or both, providing one or more interfaces for communication between computer system 200 and one or more input and/or output (I/O) devices. Computer system 200 may be communicably connected to one or more I/O devices. An input device may include any suitable device for converting volitional user input into digital signals that may be processed by computer system 200, such as, by way of example and not limitation, a touch screen, a microphone, a joystick, a scroll wheel, a button, a toggle, a switch, a keyboard, a mouse, a touchpad, or a dial. An input device may include one or more sensors for capturing different types of information. An output device may include devices designed to receive digital signals from computer system 200 and convert them to an output format, such as, by way of example and not limitation, speakers, headphones, a display screen, a monitor, a heads-up display, another suitable output device, or a combination thereof. This disclosure contemplates any suitable I/O devices and any suitable I/O interfaces 208 for them. I/O interface 208 may include one or more I/O interfaces 208, where appropriate.

In particular embodiments, communication interface 210 includes hardware, software, or both, providing one or more interfaces for data communication between computer system 200 and one or more other computer systems 200 or one or more networks. Communication interface 210 may include one or more interfaces to a controller area network (CAN) or to a local interconnect network (LIN). Communication interface 210 may include one or more of a serial peripheral interface (SPI) or an isolated serial peripheral interface (isoSPI). In some embodiments, communication interface 210 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 212 includes hardware, software, or both, coupling components of computer system 200 to each other. Bus 212 may include any suitable bus, as well as one or more buses 212, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 3 illustrates an example method 300 for creating and selecting AI based CDD (e.g., KYC) error propensity prediction models according to certain aspects of the disclosure. In certain embodiments, the method 300 is performed by one or more modules within the audit system 110.

At step 302, the audit system 110 (e.g., the data processing module 112) receives input data, as described above with respect to FIG. 1. In certain embodiments, the input data includes historical KYC audit cases and associated error data. In some embodiments, the input data is received from a business process management system of an organization (e.g., business process management system 120). In some embodiments, the data processing module 112 receives the input data from the business processing management system 120 responsive to a user request initiated from, for example, the computing system 160.

At step 304, the audit system 110 (e.g., the data processing module 112) extracts KYC audit attributes (e.g., attributes illustrated in Table 1) from the historical KYC audit cases and associated error data, as described with respect to FIG. 1.

At step 306, the audit system 110 (e.g., the data processing module 112) receives analyst attributes (e.g., attributes illustrated in Table 1), as described with respect to FIG. 1. In certain embodiments, analyst attributes may be associated with analysts that perform KYC audit processes. In certain embodiments, the analyst attributes may additionally include, for example, education, overall experience, BOI tenure, shift timings, and combinations of the same and like. In some embodiments, the analyst attributes are received from a human resources management system of an organization (e.g., human resources management system 140).

At step 308, the audit system 110 (e.g., the data processing module 112) constructs a dataset from input variables that may include at least one of the KYC audit attributes or the analyst attributes, as described above with respect to FIG. 1. In various embodiments, after the dataset is constructed, the data processing module can perform various data preparation processes. For example, in some embodiments, the data processing module can cleanse the dataset. In certain embodiments, the cleansing may include imputing missing values to respective columns in the dataset, encoding categorical variables of the dataset, scaling the dataset, and combinations of the same and like.

In certain embodiments, after the dataset is constructed, the data processing module 112 can implement feature engineering. In some embodiments, the feature engineering may include, for example, creating a group-by feature using categorical variables based, at least in part, on exploratory data analysis. In some embodiments, the group-by feature is created by finding an association between two or more of the categorical variables. In various embodiments, the feature engineering may include, for example, creating statistical columns to improve AI model functionality.

At step 310, the audit system 110 (e.g., the model generation module 113) creates at least one AI model based, at least in part, on the dataset, as described above with respect to FIG. 1. In some embodiments, the at least one AI model is created based, at least in part, on features associated with feature engineering. In some embodiments, creating AI models may be accomplished by using features (e.g., from the feature engineering), by means gradient boosting methods, by positive and un-sampled machine learning, by deep learning based on, for example, LSTM and SVM methods, by under sampling methods, and combinations of the same and like. In some embodiments, the optimization/validation module 114 optimizes and/or validates the at least one AI model using, for example, hyper parameter optimization methods, grid search and Bayesian optimization methods, voting and stacking methods, and combinations of the same and like.

At step 312, the audit system 110 (e.g., the audit module 115) selects one of the at least one AI model, as described above with respect to FIG. 1. In some embodiments, the selected AI model may be selected for predicting error propensity for a customer due diligence process. In some embodiments, the customer due diligence process is a KYC process. In some embodiments, the selected AI model is selected based on, for example, discovery of trends and patterns across different review scenarios that facilitate in the prediction of KYC reviews with low, or zero propensity for error.

In certain embodiments, the AI model may be selected based on attributes contributing to the AI model such as, for example, number of associates performing screening, review type, such as, for example, business units or sub-business units, peer reviewer location, peer reviewer primary processes, number of individuals screened, risk assessments rejected, risk levels, analyst tenure, number of documents purchased, and combinations of the same and like. Additionally, in some embodiments, the AI model can be selected based on analyst attributes.

FIG. 4 illustrates an example method 400 for processing a request relating to KYC data according to aspects of the disclosure. In certain embodiments, the method 400 is performed by one or more modules within the audit system 110.

At step 402, the audit system 110 (e.g., the audit module 115) receives a KYC request, as described above with respect to FIG. 1. In some embodiments, the audit module 115 may receive the KYC request via a user of the computing system 160. In some embodiments, the KYC request may include, without limitation, KYC requests processed by a specific analyst in order to identify analyst performance, a KYC request for a business engaging in financial activity with a financial institution, a series of KYC requests for a specific business in order to audit KYC activity for the specific business, and combinations of the same and like.

At step 404, the audit system 110 (e.g., the audit module 115) processes the KYC request with a selected AI model (e.g., the selected AI model from the method 300), as described above with respect to FIG. 1. In some embodiments, the audit module 115 processes the KYC request with the selected AI model from the method 300), as described above. In certain embodiments, processing the KYC request may include, without limitation, identifying and verifying the identity of a client when opening an account, periodically identifying and verifying the identity of a client of an open account, periodically identifying and verifying transactions (e.g., financial transactions) made by a client, and combinations of the same and like.

In certain embodiments, the processing the KYC request includes identifying cases with high propensity for error while improving process efficiency, predicting reviews with low to zero propensity for error, identifying and/or discovering trends and/or patterns across different KYC review scenarios using historical data and machine learning algorithms, and combinations of the same and like. In some embodiments, processing the KYC request may include classifying a client associated with the KYC request as high, medium, or low risk. In some embodiments, the processing the KYC request provides probability scores based on attributes related to a client associated with the KYC request. In various embodiments, the processing the KYC request includes identifying cases with high propensity for error.

While methods 300 and 400 are described with various modules performing sequential steps, it is to be understood that any component within the system 100 may perform any of the foregoing steps in various sequences, in tandem, and/or in parallel, and may be performed in real-time and/or at specific time intervals (e.g., every 5, 10, 15, 20, 30, 45, or 60 minutes). In certain embodiments, various steps within the methods 300 and 400 can be omitted. Additionally, methods 300 and 400 may be performed for a single AI model or for a plurality of AI models, and each step and/or processes of can be performed as outlined above with respect to FIG. 1. Permutations of methods 300 and 400 are readily envisioned without deviating from the scope of the disclosure. For example, various steps within methods 300 and 400 can be omitted, combined with other steps, or have additional steps added without deviating from the scope of the disclosure.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those of ordinary skill in the art may better understand the aspects of the disclosure. Those of ordinary skill in the art should appreciate that they may readily use the disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements, and/or states are included or are to be performed in any particular embodiment.

While the above detailed description has shown, described, and pointed out novel features as applied to various embodiments, it will be understood that various omissions, substitutions, and changes in the form and details of the embodiments illustrated can be made without departing from the spirit of the disclosure. As will be recognized, the various embodiments described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method for creating a model for predicting error propensity, comprising:
receiving input data comprising historical know your client (KYC) audit cases and associated error data;
extracting KYC audit attributes from the historical KYC audit cases and associated error data;
receiving analyst attributes;
constructing a dataset from input variables comprising at least one of the KYC audit attributes or the analyst attributes;
creating at least one artificial intelligence (AI) model based, at least in part, on the dataset; and
selecting one of the at least one AI model for predicting error propensity for a customer due diligence process.

2. The method of claim 1, comprising:
receiving a KYC request; and
processing the KYC request with the selected AI model.

3. The method of claim 1, comprising optimizing the at least one AI model.

4. The method of claim 3, comprising cleansing the dataset, wherein the cleansing comprises at least one of:
imputing missing values to respective columns in the dataset;
encoding categorical variables of the dataset; and
scaling the dataset.

5. The method of claim 1, comprising implementing feature engineering, and wherein the at least one AI model is created based, at least in part, on features associated with the feature engineering.

6. The method of claim 5, wherein the feature engineering comprises:
creating a group-by feature using categorical variables based, at least in part, on exploratory data analysis.

7. The method of claim 6, wherein the group-by feature is created by finding an association between two or more of the categorical variables.

8. The method of claim 5, wherein the feature engineering comprises creating statistical columns to improve AI model functionality.

9. The method of claim 1, comprising at least one of optimizing or validating the at least one AI model.

10. A system for creating a model for predicting error propensity, comprising:
memory; and
at least one processor coupled to the memory and configured to implement a method, the method comprising:
receiving input data comprising historical know your client (KYC) audit cases and associated error data;
extracting KYC audit attributes from the historical KYC audit cases and associated error data;
receiving analyst attributes;
constructing a dataset from input variables comprising at least one of the KYC audit attributes or the analyst attributes;
creating at least one artificial intelligence (AI) model based, at least in part, on the dataset; and
selecting one of the at least one AI model for predicting error propensity for a customer due diligence process.

11. The system of claim 10, wherein the method comprises:
receiving a KYC request; and
processing the KYC request with the selected AI model.

12. The system of claim 10, wherein the method comprises optimizing the at least one AI model.

13. The system of claim 12, wherein the method comprises cleansing the dataset, and wherein the cleansing comprises at least one of:
imputing missing values to respective columns in the dataset;
encoding categorical variables of the dataset; and
scaling the dataset.

14. The system of claim 10, wherein the method comprises implementing feature engineering, and wherein the at least one AI model is created based, at least in part, on features associated with the feature engineering.

15. The system of claim 14, wherein the feature engineering comprises:
creating a group-by feature using categorical variables based, at least in part, on exploratory data analysis.

16. The system of claim 15, wherein the group-by feature is created by finding an association between two or more of the categorical variables.

17. The system of claim 14, wherein the feature engineering comprises creating statistical columns to improve AI model functionality.

18. The system of claim 10, wherein the method comprises at least one of optimizing or validating the at least one AI model.

19. A computer-program product comprising a non-transitory computer-usable medium having computer-readable program code embodied therein, the computer-readable program code adapted to be executed to implement a method comprising:
receiving input data comprising historical know your client (KYC) audit cases and associated error data;
extracting KYC audit attributes from the historical KYC audit cases and associated error data;
receiving analyst attributes;
constructing a dataset from input variables comprising at least one of the KYC audit attributes or the analyst attributes;
creating at least one artificial intelligence (AI) model based, at least in part, on the dataset; and
selecting one of the at least one AI model for predicting error propensity for a customer due diligence process.

20. The computer-program product of claim 19, wherein the method comprises:
receiving a KYC request; and
processing the KYC request with the selected AI model.
